(19) United States
(12) Patent Application Publication
(10) Pub. No.: US 2005/0045392 A1
(43) Pub. Date: Mar. 3, 2005

(54) In-wheel electric motors

(76) Inventors: Boris A. Maslov, Reston, VA (US); Alexander Pyntikov, Ashburn, VA (US); Kevin Pavlov, Dulles, VA (US)

Correspondence Address: MORRISON & FOERSTER LLP, 1650 TYSONS BOULEVARD, SUITE 300, MCLEAN, VA, 22102, US

(21) Appl. No.: 10/736,896

(22) Filed: Dec. 17, 2003

Related U.S. Application Data
(63) Continuation-in-part of application No. 10/359,305, filed on Feb. 6, 2003.
(60) Provisional application No. 60/399,415, filed on Jul. 31, 2002.

(51) Int. Cl. B60K 1/00

(52) U.S. Cl. 180/65.5

(57) ABSTRACT

Improved in-wheel, near-wheel and direct-drive electric motors for cars and other vehicles. This motor can be cheaper, lighter, more powerful, more efficient, and more reliable than other direct-drive motors. Its high torque-density and high performance allow it to produce the same peak power as heavier, bigger motors. That helps greatly with the handling issues caused by too much unsprung mass. The motor control system can adapt to the vehicle's operating conditions (like starting, accelerating, turning, braking, and cruising at high speeds). That provides better performance. The motor's low-voltage, low-current design helps reduce heat and weight and leads to lower motor cost. The motor can still operate with some faults, offering “get home” capability. It offers all the benefits of in-wheel motors: efficiency, compactness, direct traction control, quiet, simple driveline. And it adds to those benefits, while reducing or eliminating the drawbacks other in-wheel motors.

### STATEMENT OF RELATED APPLICATION

This application is a continuation-in-part of U.S. application Ser. No. 10/359,305 filed Feb. 6, 2003, which application claims priority from commonly assigned, copending U.S. application Ser. No. 09/826,423 of Maslov et al., filed Apr. 5, 2001, commonly assigned, copending U.S. application Ser. No. 09/826,422 of Maslov et al., filed Apr. 5, 2001, commonly assigned, copending U.S. application Ser. No. 09/966,102, of Maslov et al., filed Oct. 1, 2001, commonly assigned, copending U.S. application Ser. No. 09/993,596 of Pyntikov et al., filed Nov. 27, 2001, commonly assigned, copending U.S. application Ser. No. 10/173,610, of Maslov et al., filed Jun. 19, 2002, commonly assigned, U.S. application Ser. No. 60/399,415, of Maslov et al., filed Jul. 31, 2002, commonly assigned, copending U.S. application Ser. No. 10/290,537, of Maslov et al., filed Nov. 8, 2002, commonly assigned, copending U.S. application Ser. No. 10/353,075 of Maslov et al., filed Jan. 29, 2003, and commonly assigned, copending U.S. application Ser. No. 10/353,075 of Maslov et al., filed Jan. 29, 2003, each of which is hereby incorporated by reference in its entirety.

### FIELD OF INVENTION

This invention relates to in-wheel, near-wheel and direct-drive electric motors for vehicles.

### BACKGROUND OF THE INVENTION

This invention relates to improved in-wheel, near-wheel and direct-drive electric motors for cars and other vehicles. An in-wheel adaptive motor of this invention may cheaper, lighter, more powerful, more efficient, and more reliable than other direct-drive motors for electric vehicles.

Electric vehicles driven by motor-wheels have advantages of compactness, high operating efficiency both as a motor driving the wheel and regeneration recovering the kinetic energy of the vehicle, and as a simple driveline. The superior power and torque density allow the hub motors to create four wheel independent control on a vehicle.

Some problems of in-wheel motors in cars include the possible increase in unsprung mass and the consequent effect on ride and handling; in addition, the effect of heat from braking negatively effects motor performance. Packaging motors in the wheel adds an additional vulnerability to environmental conditions resulting in potential damage of a motor in this exposed position.

An in-wheel adaptive motor of this invention provides solutions to many of these problems. In cars, in-wheel adaptive motors deliver high power with low unsprung mass and high torque-density. The motor will fit in the vehicles current production wheel “rim” eliminating the need to design special tires for the application. The motor control system can adapt to the vehicle's operating conditions (such as starting, accelerating, maneuvering, turning, braking, and cruising at high speeds), thereby consistently providing higher performance.

The high torque-density and high performance allow an in-wheel adaptive motor that is lighter and more compact to produce the same peak power as heavier, bigger motors.

This in-wheel adaptive motor also has a distributed architecture. The total current the motor requires is divided up into segments, this distribution enables the use of low cost, off the shelf power electronics. This low-voltage, segmented current characteristic

The distributed architecture of an in-wheel adaptive motor also helps with fault helps distribute the heat being generated over a large area and reduces the weight, while tolerance. Even if one or more electromagnetic circuits fail, the motor can still operate. still offering high power. It also leads to lower motor costs. This enables a “reduced function operation”. With four in-wheel motors in a car, even a catastrophic event resulting in the failure of one or two of the motors may be overcome; the other wheels have the ability to move the vehicle, providing the driver with a safe “non-stranding” powertrain.

An in-wheel adaptive motor of this invention thus offers all the benefits of in-wheel motor architectures: efficiency, compactness, direct traction control, quiet, simple driveline. And it adds to those benefits, while reducing or eliminating the drawbacks.

The adaptive motor architecture allows for “in wheel” (putting a motor directly into the hub of a driven wheel), “near wheel” (putting a motor next to, but not in, the wheel), and other “direct drive” configurations where the motor drives one or more wheels without going through a transmission. These configurations are shown in FIG. 11. Although not shown, an offset between the motor and wheel may be used in the near-wheel configuration, as well.

Many of the advantages of in-wheel adaptive motors also apply to near-wheel and other direct-drive configurations. And while most of the discussion here relates to cars, the advantages of these motors are not limited to cars. Many also apply to bicycles, wheelchairs, scooters, trucks, buses and other vehicles with wheels.

### Advantages of In-Wheel Motors

The natural rotary motion of an electric motor matches nicely with the natural rotary motion of a wheel. That gives a simple elegance to fitting an electric motor directly into the wheel of a vehicle. This is not a new idea—Ferdinand Porsche designed electric cars in 1900 and 1902 using in-wheel electric motors.

Many car designers continue to believe that in-wheel, or “hub,” motors provide the best architecture for electric cars. Some of the main advantages of in-wheel motors are higher efficiency, better traction control, weight and space savings, and quiet operation.

### Higher Efficiency

Direct-drive wheel systems in cars consist of a motor drive coupled directly to a driven wheel without any intervening transmission or differential. This arrangement simplifies the drive train considerably. In bicycles, in-wheel motors eliminate the need for any efficiency-robbing mechanism that uses friction to rotate the wheels.

With today's cars, engines create rotating power, or torque. That energy is transferred to a set of gears, or a transmission. The gears turn a drive shaft and ultimately spin the wheels. Typically, at least Ten percent of the power created by the engine is lost transferring energy to the wheels.

The ability of an in-wheel motor to start from zero speed makes it possible to eliminate the need for a clutch in cars. The available speed range usually makes transmission gears unnecessary. Planetary gears allow the motor to run at much higher speed for a given road speed, this usually produces a much higher torque at the motor's peak torque range. Using them may add considerably to the efficiency of the complete power train for some applications.

As much as three percent of the power created by the engine in a normal car may be lost to brake drag. Because the in wheel motor has a very fast response the brake drag can be eliminated by using high roll back calipers. In addition, with an in-wheel motor, regenerative braking can possibly recover 50 to 70% of the vehicle's kinetic energy . Road conditions and compromises in stability may reduce this number to 20-30%

Eliminating the clutch and transmission, using regenerative braking increases the overall efficiency of the motor system. The higher efficiency of an in-wheel motor may, in certain cases, be very high.

In solar cars, where the very limited electrical energy available makes efficiency paramount, in-wheel motors are very popular. Some have reported the peak efficiency of those motors to be as much as 98%.

### Weight and Space Savings

Putting an electric motor in or near the wheel in a car saves a lot of weight and space. First, the engine and transmission are removed opening up the under hood area. The motors are integrated into the wheels. The vehicle has the same propulsion capability, but the effect on the passenger compartment has changed significantly. Hub motors providing equivalent power output as the engine, will usually weigh less than the engine & related components

Second, there is no need for multi-speed transmissions or differential devices (including drive shaft, universal joints and transfer case) between the motor and the wheels. Eliminating those devices saves weight and space.

Note that fixed ratio, planetary gears are often used in in-wheel, near-wheel, and other direct drive configurations. The distinguishing feature is that in direct drive the gears are not “shifted” or changed. Having more than one motor in a car effectively excludes gear changing as a method of optimizing efficiency, as the complexity is too great.

Third, with in-wheel motors space and weight can be saved by eliminating, down-sizing and “repackaging” vehicle systems. In-wheel motors can perform functions without requiring the additional systems required by normal cars. For example, systems like antilock brakes, traction control, power steering and all-wheel drive can be consolidated or made redundant.

Fourth, the ability to locate systems (apart from the in-wheel motors) anywhere in the vehicle gives flexibility in locating important masses to improve weight distribution. That also provides improved crash zone design possibilities, additional flexibility in locating passengers and luggage, and ability to provide a more comfortable and roomy interior, such as by lowering the floor.

### Improved Traction Control and Handling

Four in-wheel motors almost naturally deliver all-wheel drive. When all the wheels are driven, wheel spin is minimized. When a car is stuck in deep snow or the pavement is slick, traction can be applied to the tire that has grip. The car can be better controlled, even under difficult road conditions, than with today's high-end traction control systems for normal cars.

Four in-wheel drive vehicles require a distributed control system that can deliver the appropriate control to each individual drive motor. This need for a distributed control system may seem like a drawback. But conventional four-wheel drive systems also require a relatively complex control system to regulate the performance of the drive train.

In addition, a modern conventional four wheel drive train and transmission system is quite complex mechanically and very expensive to manufacture. The complexity required to implement control in an electric four in-wheel drive system can be reduced to programming a controller chip

With this architecture, each in-wheel motor can be controlled independently. Control is instantaneous. This independent and instantaneous traction control over each wheel provides “true” four wheel drive, since each wheel can be turned or stopped independent of any other wheel. Different wheels can even turn in different directions at the same time.

This instantaneous and independent control of the adaptive car's wheels enables many functions other than just propulsion. This control translates into some clear advantages over gasoline and conventional electric cars. First, an adaptive in-wheel motor can produce high torque at zero and low wheel speed.

Second, an adaptive in-wheel motor can both accelerate and decelerate the wheel. Third, torque generation of an adaptive motor is very quick and accurate, for both accelerating and decelerating. An adaptive motor provides fast frequency response and low inertia.

Fourth, generating torque in the right wheel in an opposite direction from torque generated in the left wheel permits direct yaw moment control. Movement is possible in two dimensions, right and left in addition to just backwards and forwards.

Fifth, motor torque becomes easily comprehensible. Little uncertainty exists about the driving or braking torque exerted on a wheel. With a transmission, differential and other drive line components between a gasoline engine and a car's wheels, the actual torque exerted on the wheel may be hard to determine. Brakes also make actual applied torque hard to determine.

Further, an in-wheel motor with no planetary gears will make almost no noise. No part will be moving faster than the wheels. It sounds as though the vehicle is coasting. The difference, even compared to a conventional electric vehicle, can be dramatic.

### Problems with In-Wheel Motors

The advantages of in-wheel motors for all kinds of vehicles would seem to make them popular. But they are not. Existing motor technology cannot easily meet the high performance demands required of in-wheel motors. Several problems arise.

### Unsprung Mass

Putting a heavy motor in a wheel of a car increases its unsprung mass. That can have dramatic, negative effects on the car's comfort, handling and road-holding performance. In a conventional drive system (electric or gasoline), the only unsprung mass in the car are the wheels and a small portion of the drive train. With an in-wheel motor system, the motors become part of the car's unsprung mass.

Most electric motors and all internal combustion engines are too heavy to be removed from the body of a car and put into one or more of the drive wheels. An electric motor suitable for use in a direct-drive system must have a relatively low mass and high torque-density. In addition, direct-drive motors must have physical dimensions that allow them to be located near or in a drive wheel.

Too much weight in a car's wheels will have several effects on suspension and ride. The higher the vehicle's unsprung mass, the more force with which the suspension's springs will compress and extend under hard cornering or over bumps. This causes excessive movement in the suspension, which produces a poor ride and reduces cornering grip. In addition, higher unsprung mass requires stiffer shock absorbers to control the extra spring movement, which also contributes to a stiff, harsh ride.

This problem may not seem great. But the effects are substantial and difficult to overcome. The most stubborn drawback of in-wheel drive motors has been the weight that they add to each wheel. That, more than any other reason, has limited the adoption of in-wheel motor systems in electric vehicles. Some, like GM with its AUTOnomy concept car, have given up on in-wheel motors for cars, fearing that they will always be too heavy.

### Problems from Location in the Wheel

A motor in a car's wheel becomes much more exposed than an engine under the car's hood. Friction braking may create heat that affects motor performance. Electrical cables leading to the wheels may need to be heavy (to carry large currents), long and unless protected, liable to be damaged. The motor itself also becomes vulnerable to wet, heat and damage in a collision when put in a car's wheels.

Putting a powerful motor in the small space available in a vehicle's wheel may cause problems. For example, there may be little room left for a cooling or lubrication system. And the limitations of space and unsprung mass may limit the power of motor that may be used. Trying to increase power without increasing weight by using planetary gears will bump into the space constraints as well.

### Low Efficiency Over Changing Conditions

Electric motors can be designed to operate very efficiently within a limited range of speeds. Outside of this range, they quickly lose efficiency. So while electric motors can be 80% to 90% efficient (or even more) in ideal conditions, over the typical varying driving cycle the efficiency of electric motors may fall to less than 50%.

These differences in efficiency between types of electric motors can be very high. Because compromises are so difficult to avoid, one attempt to make a practical electric propulsion system for a car, U.S. Pat. No. 5,549,172, goes to the extreme of using two motors in the car.

That invention recognizes that no existing motor performs well over the whole range of car operating conditions. Accordingly, that invention tries to upgrade overall system performance by combining a highly efficient motor at low speeds with a highly efficient motor at high speeds. The obvious disadvantage is the need for two complete, separate electric motors.

With an in-wheel motor system, finding one type of motor that provides peak performance at low speeds and high speeds, and in other varying conditions, is difficult. And using more than one type of motor in an in-wheel system seems impractical.

### High Torque Required

An in-wheel or direct drive motor has to produce high torque to turn the wheel. In that case, motor torque must equal the wheel torque. Not having a range of gears available will make it difficult to get enough torque at all speeds.

For example, pedaling a tricycle up a steep hill is impossible. A human cannot generate enough torque to do that. But a bicycle with 21 gears can be pedaled up even the steepest hills. The same is true with a gasoline car. If it had only one gear, it would be practically useless. Three or four gears, or a variable transmission, are a necessity to perform adequately.

Finding an electric motor that can provide sufficient peak torque over the needed range of operating conditions will not be difficult. But almost any suitable motor will be too big, heavy and expensive. Planetary gears may help with the problem. But existing motors typically do not have sufficient torque density to be a practical in-wheel motor.

In addition, an electric motor usually needs to operate at high voltage and high current to generate enough torque and power. High current means a bulky, heavy, expensive motor and thick power cables. High voltage means a safety issue for both car passengers and repair personnel. Neither is an attractive choice.

### High Cost and Complexity

A considerable amount of work has been done to develop motors suitable for in-wheel use, but it is a formidable task. This is mainly because of the cost and complexity of producing the very small, high-torque, high-power motors required.

Cost becomes a major factor if motors are used in all four wheels of a car. Induction motors are usually the cheapest, simplest, most powerful, and most reliable electric motors. They are ill-suited for in-wheel motors.

Currently, the best motors for in-wheel use are “brushless DC” motors. A high-performance motor of this type uses expensive permanent magnets and requires a complicated control system. That adds to the cost and complexity of an in-wheel motor of this type. While these motors may work well in expensive prototypes and concept cars, they may not translate to practical production cars.

### SUMMARY OF THE INVENTION

In one embodiment, the invention is a vehicle having two or more wheels, and one or more electric motors, each mounted in an in-wheel, near-wheel, or direct-drive manner, wherein at least one motor is an in-wheel motor with torque density of at least 20 Nm/kg. The electric motors have at least a rotor and a stator. The stator has a plurality of stator core elements arranged in groups. Each group of stator core elements is with a corresponding one of the phases of a multiphase machine, the stator core elements in each group being structurally and electromagnetically isolated from the stator core elements in each other group, and a controller for controlling electrical flow in each group of stator core elements independently of electrical flow in each other group, whereby each phase of the multiphase machine is controlled independently of each other phase.

### BRIEF DESCRIPTION OF THE DRAWING FIGURES

FIG. 1 shows one example of a bicycle with an in-wheel adaptive motor of this invention.

FIG. 2 shows an exploded view of the components in a wheel hub of the bicycle shown in FIG. 1.

FIG. 3 shows a three-dimensional perspective view of one side of an adaptive motor and batteries within the wheel hub of the bicycle of FIG. 1.

FIG. 4 shows a three-dimensional perspective view of the other side of an adaptive motor and batteries within the wheel hub of the bicycle of FIG. 1.

FIG. 5 shows a block diagram of one example of four in-wheel adaptive motors of this invention used in a gasoline/electric series hybrid electric car.

FIG. 6 shows the basic physical structure of one example of an in-wheel motor for the car of FIG. 5.

FIG. 7 shows one example of a stator core segment of the motor of FIG. 6.

FIG. 8 shows one example of a rotor of the motor of FIG. 6.

FIG. 9 shows a block diagram of one example of power electronics that energize the stator windings in groups of three in a motor for an adaptive electric car.

FIG. 10 shows a diagram of: an in-wheel motor configuration (FIG. 10(a)), a near-wheel motor configuration (FIG. 10(b)), and a direct drive motor configuration (FIG. 10(c)).

### DETAILED DESCRIPTION OF THE INVENTION

### Advantages of In-Wheel Adaptive Motors

In-wheel adaptive motors solve or reduce many of the problems with existing in-wheel motor systems. In-wheel motors take up less space, have lower weight than conventional motors, provide more power than existing electric motors, are more efficient than prior art electric motors, and provide greater reliability and performance than existing electric motors while being more economical to produce.

There are various features of the electric motors of the present invention that provide for the above-mentioned advantages over prior art design. These features include segmented magnetic circuits enabling premier torque production, fast response and precise control of motor output, and soft magnetic electromagnets and shaped pole heads which enable unprecedented torque density. Further, independent pole control and phase advance enables greater than average efficiency for an electric motor.

The adaptive control systems of these motors include a digital signal processor that activates the electromagnets by analyzing motor position, desired torque, and energy management system, and employ adaptive algorithms that dynamically adjust the current and excitation sequence of each electrical phase to maintain the motor at peak efficiency and minimize total energy consumption.

Further, the motors themselves permit the use of multiple phases (>3) to enable high levels of fault tolerance and produce low speed torque allowing for the elimination of heavy transmissions and gears.

### High Torque Density, Low Unsprung Mass

The in-wheel adaptive motor technology of this invention produces much higher torque density than that of existing electric motor designs. The comparison illustrated in Table 1 shows a set of four in-wheel adaptive motors compared to four other motors of conventional design used in electric cars, to illustrate the benefits of the adaptive electric motors of the present invention.

TABLE 1
The performance of four 17 kW adaptive motors (providing a total
of 68 kW) compared with four other conventional motors.

| | Adaptive | | | | |
|---|---|---|---|---|---|
| Machine | Motor | | | | |
| Characteristics | Design | Motor 1 | Motor 2 | Motor 3 | Motor 4 |
| Peak Power | 68 (17 | 56 | 100 | 150 | 122 (30.5 |
| (kW) | kW in | | | | kW in |
| | each of 4 | | | | each of 4 |
| | motors) | | | | motors) |
| Peak Torque | 2600 | 1069 | 550 | 2750 | 1800 |
| (Nm) | | | | | |
| Peak Voltage | 42 | 500 | 300 | 220 | 220 |
| (Volts) | | | | | |
| Active Mass | 120 | 2000 | 86 | 220 | 116 |
| (kg) | | | | | |
| Torque Density | 21.7 | 0.5 | 6.4 | 12 | 15.5 |
| (Nm/kg) | | | | | |
| Notes | Brushless | Brushed | Brushless | Brushless | Brushless |
| | DC (four | DC | AC | AC | AC (four |
| | in-wheel | | | | in-wheel |
| | motors) | | | | motors) |

The in-wheel adaptive motor architecture maximizes torque rating for available weight and volume. Its advanced magnetic materials and design eliminate weight while maintaining power.

High torque may be a chief distinguishing feature of in-wheel adaptive motors. Conventional electric motors cannot actively manage torque well or influence the torque at design level. That is because the choice of a specific type of conventional motor for a particular application largely determines the available torque profile.

An in-wheel adaptive motor, by contrast, may typically have extremely high torque, as well as high starting torque. An in-wheel adaptive motor may also, in its adaptive control system, include special algorithms to increase torque if necessary. The allows the control system to actively manage torque across a range of operating conditions that the motor may be needed to encounter.

An adaptive electric motor, with its high torque density, provides more torque per kilogram of weight than existing motors. Having high torque density allows an adaptive electric motors to be used as an in-wheel motor, or “hub motor,” without adding an undue amount of unsprung mass. The compact nature of an adaptive electric motor makes it well-suited for use directly within wheels.

### High Performance and Efficiency Over Wide Speed Range

Powering vehicles with electric motors poses real problems. Operating conditions change constantly. Starting a vehicle in motion requires that the motor exhibit the ability to produce high torque at low speed. Maintaining the speed of a vehicle while cruising, however, requires the motor to exhibit high efficiency, to be economically practical. Limits on battery power, further, restrict the range of a vehicle using the motor. To enable the vehicle to have the speed and acceleration necessary for highway conditions, such as is needed for passing, the motor must be able to produce bursts of high torque at high speeds.

Electric motors operate most efficiently at steady speeds. In many cases, an electric motor can operate at over 90% efficiency, leaving little room for efficiency improvement. To achieve this level of efficiency, however, it is assumed that the motor's operation is within a narrow range of operating speed. Electric cars are generally operated under conditions which do not fit that assumption.

In-wheel adaptive motors permit significantly greater efficiency than existing in-wheel motors, particularly when operating at variable speeds. Adaptive control for individual electromagnetic circuits allows optimal performance and efficiency. In applications such as electric cars where operating conditions vary widely, an in-wheel adaptive motor may have as much as 50% greater overall efficiency than a prior art motor.

Greater efficiency in an electric motor powering a car extends the range of the car for a given battery set and battery technology. A goal of 90% efficiency in the power train over 90% of the typical driving cycle, both city and highway, may become possible.

Optimal performance over a wide range of operating conditions makes in-wheel adaptive motors best suited for electric cars, one of the most demanding application for electric motors.

### Low Voltage, Low Current, High Power

In-wheel adaptive motors can use a distributed architecture. That allows the motor to deliver high power while operating at low voltage, 50 volts or under. In addition, the peak currents in each phase of the motor can be limited to 100 amps or less.

Even with these low voltages and low per phase currents, a set of four in-wheel adaptive motors can produce 68 kW of power and 2600 Nm peak torque, with a torque density of 21.7 Nm/kg.

Normally high power at low voltage means high currents, sometimes over 1,000 amps. In an in-wheel adaptive motor, the architecture distributes the total current across several “phases,” or electromagnetic circuits, of the motor. That allows the motor to produce high power even though the system voltage remains low and the current in each electromagnetic circuit also remains low. This is advantageous for the following reasons.

A distributed motor architecture, with its low voltage, improves human safety. In an electric car, the motors of the present invention can deliver high power as low as at 50 volts or less, which will not cause a fatal shock even in an accident. Existing electric car motors typically operate at much more dangerous voltages, typically from 250 volts to 500 volts. When the motor is disposed in the wheel, the need for cables that carry such voltages to the wheel poses an additional safety issue.

A motor with distributed architecture also improves safety by providing greater fault tolerance. In an emergency, a motor can continue to operate even when one or more electromagnetic circuits of the motor break down.

In cases where a battery or fuel cell is used (such as in an electric car), a motor that operates at a low system voltage allows the battery or fuel cell to have fewer cells. Moreover, with lower current in each phase, less heat is generated.

The distributed architecture lowers cost by allowing cheaper power electronics to be used. It also allows smaller, lighter motors to be made with light wiring, switches and connectors. In addition, it opens the path to lower cost battery and fuel cell technologies, simplified battery and fuel cell management, and wider packaging options.

### Adaptive Controls

In-wheel adaptive motors provide dynamic control over a range of parameters. An in-wheel adaptive motor provides optimal performance by dynamically adapting its controls to changes in user inputs, machine operating conditions and machine operating parameters.

Isolating the in-wheel adaptive motor's electromagnetic circuits allows effective control of more independent motor parameters than in existing motors. That gives greater freedom to optimize the performance of the motor. The results are in-wheel motors that are cheaper, smaller, lighter, more powerful, and more efficient than conventional designs.

To improve energy efficiency, an in-wheel adaptive motor control system can adapt almost instantaneously to an adaptive electric car's operating conditions, including starting, accelerating, turning, braking, and cruising at high speeds. To improve motion control, the motor controller can directly and almost instantaneously adapt the motion of the wheels to changes in road conditions or driver inputs.

Adaptive controls can also improve operation of in-wheel adaptive motors to reduce noise, vibration and harshness (“NVH”), eliminate or reduce audible noise, control load spikes, and provide fail-safe operation. In addition, adaptive controls can be used to compensate for changes in motor operation due to wear and tear, and to reduce torque ripple and other poor motor characteristics.

Finally, adaptive controls can give in-wheel adaptive motors the ability to produce a vehicle with much better traction control than conventional in-wheel motors. Adaptive controls handle torque much better than conventional controls. That translates into better performance at low and high speeds. Better control results in better performance. Complex tasks, such as anti-lock braking and torque steering, become relatively simple programming tasks with adaptive controls.

### Fault Tolerance

In-wheel adaptive motors provide excellent fault detection and fault tolerant operation. With independent electromagnetic circuits in adaptive motors, the motor controller can detect and isolate faults down to the electromagnetic circuit level.

That fault helps greatly when an electric motor is exposed in the wheel of a vehicle. In most cases, an in-wheel adaptive motor may operate on no more than 30% of its total electromagnetic circuit capacity, when necessary. So if, for example, an electromagnetic circuits in the motor stops operating, a controller can detect that.

The controller then has at least two adaptive options. It can take down the electromagnetic circuit, and spread the torque load across other electromagnetic circuits. Or it may take down the entire motor, so the torque load is spread across the other in-wheel motors. In either case, the car's driver can “limp home” until repairs can be made. In some cases, the effect of faults may not even be noticeable. The fault tolerance makes in-wheel adaptive motors more reliable than conventional electric motors, and reduces the possibility that a driver may be stranded.

With four in-wheel adaptive motors, a car or other vehicle has extra protection against failure, accidents or even (in the case of military vehicles) attack. Even if one or more motors becomes unavailable, an adaptive electric car or other vehicle can compensate for that and continue to run, although the vehicle performance may be diminished.

### Effective Regenerative Braking

An in-wheel adaptive motor makes regenerative braking more effective. Its adaptive control system can handle complex control schemes. Where regenerative braking may be complex to implement for a simple control system, the sophisticated nature of an adaptive control system makes regenerative braking much less of a challenge.

Also, regenerative braking can generate great amounts of electrical power. When a car slows from 60 mph to a stop, as much as 20 kW of electricity may be generated. A standard battery cannot handle rapid recharging at this level.

An in-wheel adaptive motor, with the proper battery, can handle up to 70%, and perhaps more, of the energy generated by regenerative braking. That compares with many existing electric cars that can store only about 5% of the electricity from sharp braking, allowing the remaining energy to go unrecovered.

### Lower Cost

The motor system for the adaptive electric car derives its low cost from a variety of factors. First, the architecture's flexibility allows scalable, common components. Rather than being a single stator assembly, each electromagnetic circuit can be a separate component. That simplifies, and thus lowers the cost, of manufacturing castings, forgings, and powdered metals. Also, the low system voltage of the motor—less than 50 volts—allows the use of cheaper components, such as MOSFETs rather than IGBTs, and easier manufacturing, since wires are of a smaller gauge.

This invention may include in-wheel, near-wheel and/or direct drive electric motors used in a variety of vehicles. The following description provides two examples of this invention: an in-wheel motor used in a bicycle, and a set of four in-wheel motors used in a car.

The disclosures of the following published applications and U.S. patents provide examples of devices and methods related to the in-wheel adaptive motor of this invention. Therefore, by this reference, we incorporate into this application the disclosures of:
U.S. application Ser. 2003/0213630 entitled “Electrically Powered Vehicles Having Motor and Power Supply Contained Within Wheels.”
U.S. Pat. No. 6,617,746 entitled “Rotary Electric Motor Having Axially Aligned Stator Poles and/or Rotor Poles.”

### In-Wheel Adaptive Motor in a Bicycle

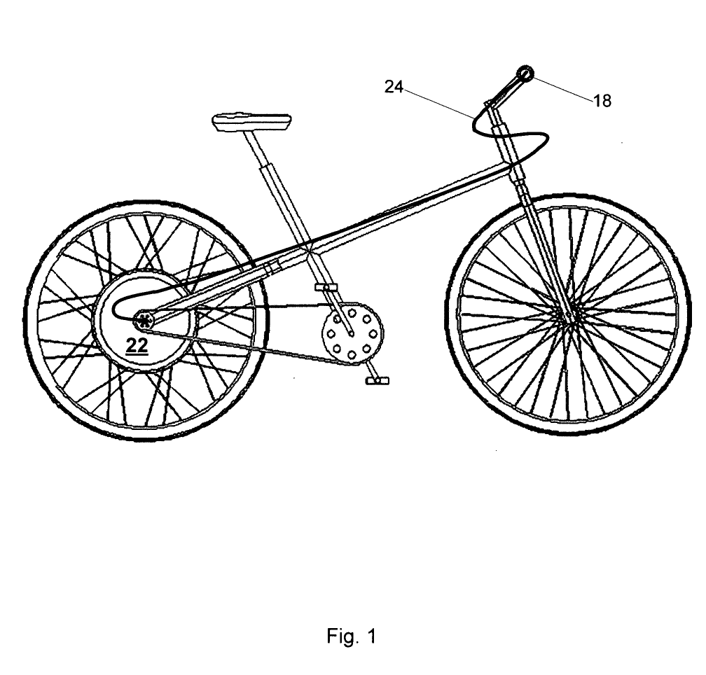

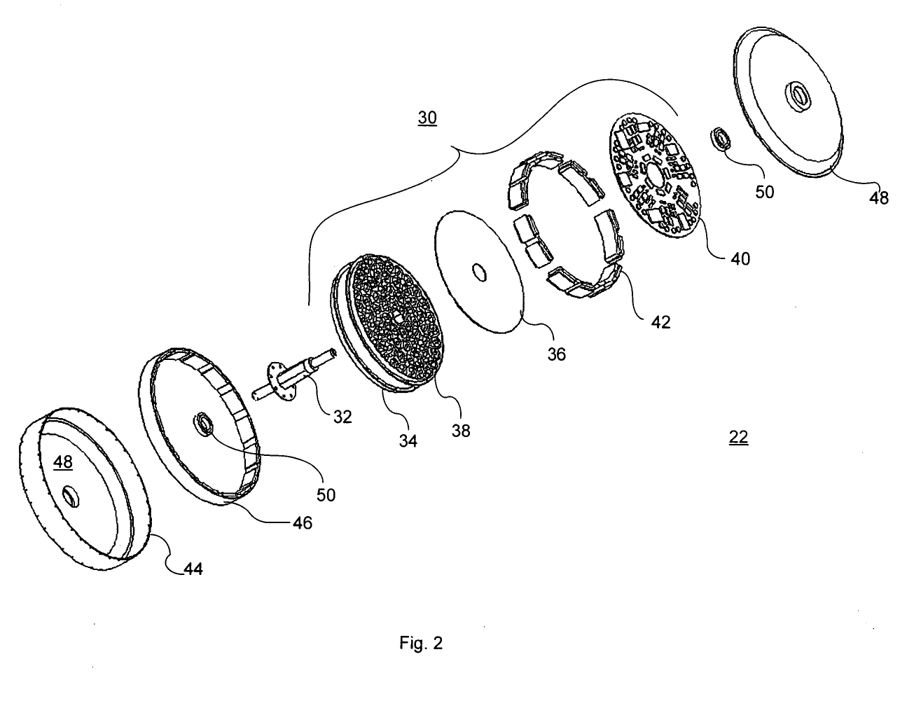

FIG. 1 shows one example of an in-wheel adaptive motor of this invention used in a bicycle. The invention, however, is equally applicable to single or multi-wheeled vehicles. As described in more detail below, the back wheel contains the motor, controller, and batteries. A rider can move the bicycle by using the pedals, the motor, or both. A rider operates the motor by turning a throttle 18 on the handlebars. The throttle is connected to the motor controller through the cable 24.

FIG. 2 shows an exploded view of the contents of the back wheel hub 22. The elements indicated by the bracket 30 generally form the stator portion of the motor. When assembled, they become part of the bicycle frame and remain fixed in position. In fact, the axle 32 is bolted onto the frame.

The batteries 38 sit in the space between the stator frame 34 and two plates 36 (only one plate is shown). In this example, the batteries are rechargeable “D” cells. A round plate 40 contains the circuit elements and circuit connections that make up the motor control system. The motor control system provides electrical current to the motor phase windings. It also controls battery charging.

The motor control system connects to the throttle by the cable 24. It also connects to the windings for each of the separate motor phases. Finally, it connects to the batteries, both to receive power to pass on to the motor and to control charging of the batteries from an outside power source.

The motor control system dynamically adapts to changes in user inputs (in this example the throttle), operating conditions (for example, angular speed and rotor position) of the motor, and operating conditions of the vehicle (for example, climbing a hill).

This example has seven electromagnet cores 42, each wound with copper wire to form an electromagnetic circuit, or “phase” of the motor. They sit around the outside of the stator frame 34. Each core winding is a separate electromagnetic circuit, and is separately controlled.

In this example, the stator frame 34 is made of aluminum, a non-magnetic material. That helps isolate the electromagnetic circuits. Substantially eliminating electromagnetic and electrical interference between the electromagnetic circuits is done to increase the effective response of the motor to control and optimization.

A rotor frame 44, two side plates 48, a rotor 46, and bearings 50 make up the rotor assembly. The rotor has a back iron ring supporting sixteen permanent magnets, mounted on the inside of the rotor.

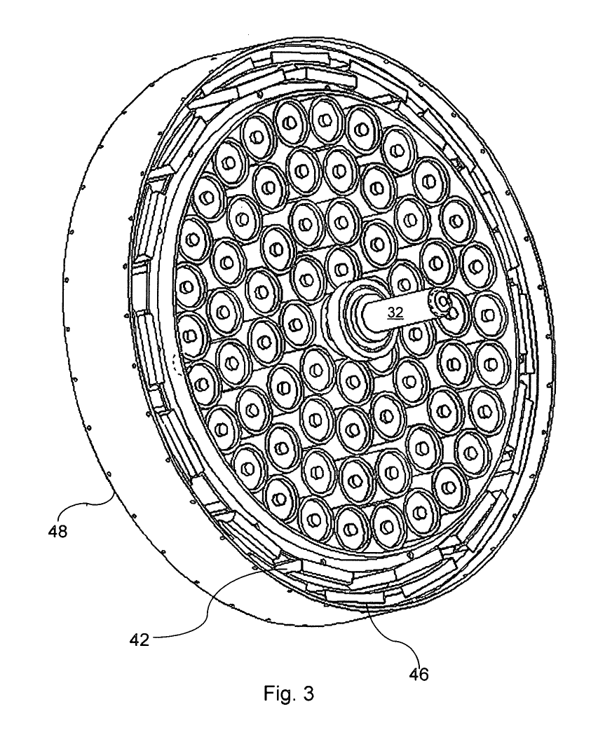

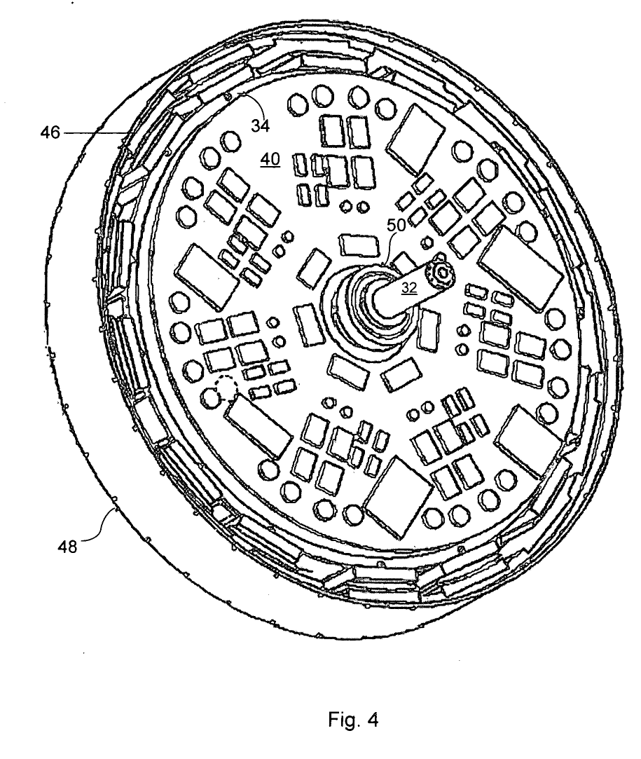

FIGS. 3 and 4 show an assembled motor form both sides. When assembled, the stator components form a cylinder with a relatively narrow width, and electromagnets on the outside. The rotor surrounds that stator. There is narrow radial air gap between the stator electromagnets and the rotor permanent magnets, allowing magnetic forces to turn the rotor around the stator.

The outer plates 48 are mounted to the frame 44 to enclose the entire contents of the hub. The tire is mounted to the rotor frame 44 by spokes 56. As the motor rotates, so does the wheel, and the bicycle moves.

As an alternative, the tire may be mounted directly to the rotor frame. The spokes could then be eliminated, and the hub diameter is increased to the inner dimension of the tire. That modification creates more space to hold a more powerful motor or additional batteries.

### Four In-Wheel Adaptive Motors Used in a Car

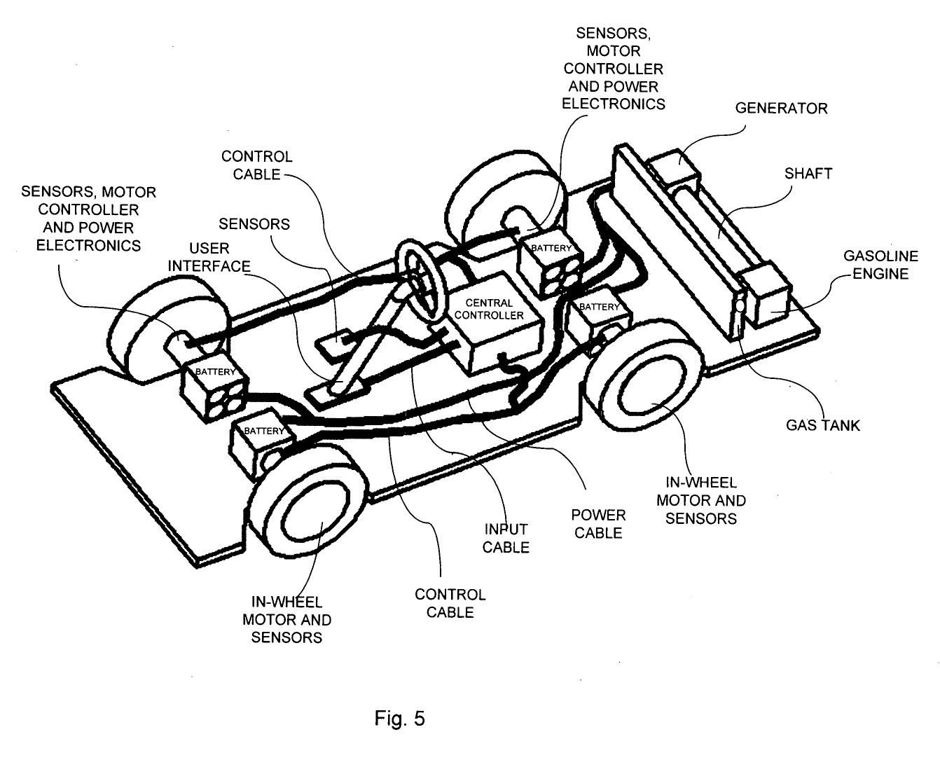

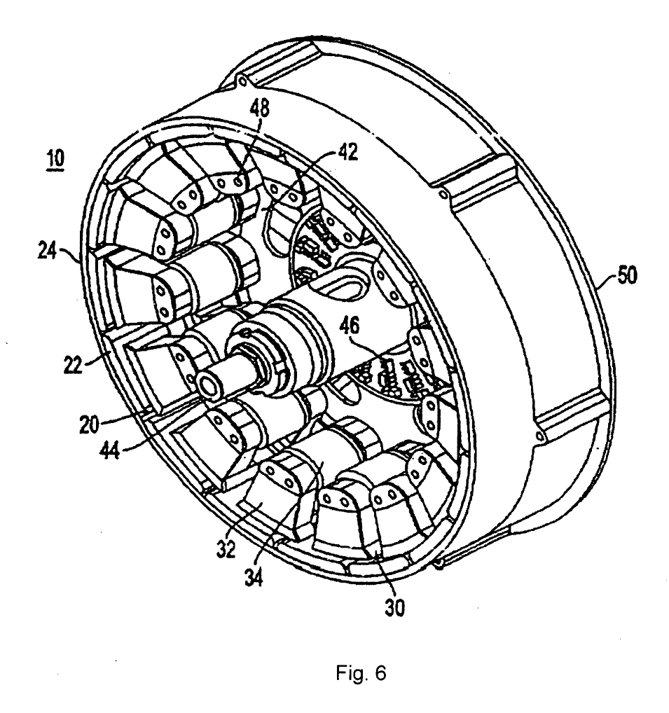

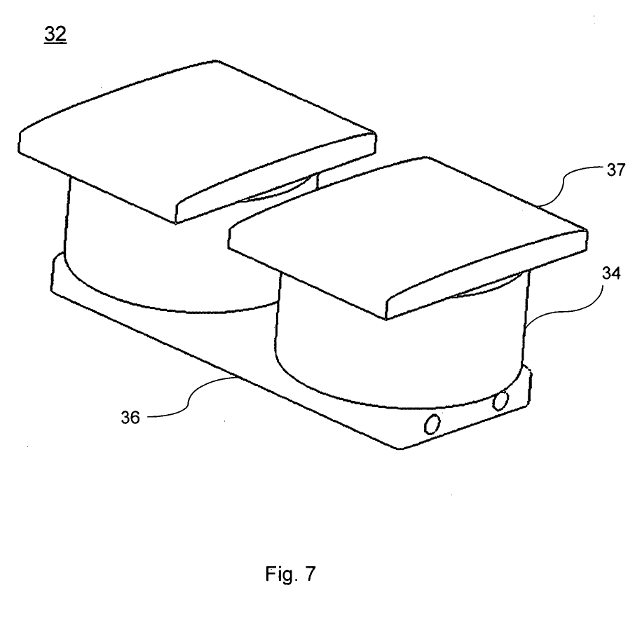

FIG. 5 shows one example of four in-wheel adaptive motors of this invention used in a gasoline/electric series hybrid electric car. This description will focus on the in-wheel adaptive motors.

The example of FIG. 5 has four in-wheel adaptive motors. Other examples of adaptive motors of this invention may have two in-wheel motors, two or four near wheel motors, or one or more motors separate from the wheels but directly driving them.

In-wheel adaptive motors can also be used in gasoline cars. For example, a car with the front wheels powered by a gasoline engine could have the rear wheels powered by two in-wheel adaptive motors. That may match the power of a sports car with the fuel economy of compact.

Preferably these motors will be direct drive, but gears can be used, particularly fixed ratio gears when more peak torque is desired. Those skilled in the art, of course, will recognize that there are applications where variable-ratio gears may be used and might be preferable. Planetary gears may be used even in an in-wheel motor to gain more peak torque with a smaller motor. Preferably each of the four in-wheel motors has the same configuration. That allows for the motors to be standardized and interchangeable.

In this example, each motor is rated at 17 kW peak power, 2600 Nm peak torque, 42 V system voltage, and less than 30 A peak current per electromagnetic circuit. Each motor has 30 kg active mass. That results in a torque density of 21.7 Nm/kg.

FIG. 2 shows the general configuration of the rotor around the stator in the adaptive electric motor of this example. This rotor has two belts of sixteen permanent magnets each, with the two belts arranged side by side along a back ring. Instead of using permanent magnets, the rotor may also have wound electromagnetic poles to increase magnetic flux and/or to help with field weakening at high speeds.

The two belts of sixteen permanent magnets each have the magnets equally spaced along the air gap and affixed to a non-magnetic circular back plate. The magnetic polarity of the magnets in each belt alternates from north to south going around the belt.

The belts lie side by side along the back plate, as shown in FIG. 5. The magnetic polarity of each belt's magnets is offset so that a north pole in one belt lies alongside a south pole in the other belt, and vice versa.

The magnets of each ring successively alternate in magnetic polarity. The magnetic flux produced by the rotor's permanent magnets may be enhanced by adding a magnetically permeable element (not shown) mounted to the back of the rotor permanent magnets.

The number of rotor magnets is just for this example. That number may be changed. For example, fewer magnets spaced at greater distances may produce different torque and/or speed characteristics.

The choice of which permanent magnets to use usually means trading better performance for lower cost. In this example the permanent magnets are NdFeB (neodymium iron boron) permanent magnets of a nominal BHmax or energy product ranging between 238 to 398 kJ/m 3 (30 to 50 MGOe).

Shaping the magnets in rounded sectors with square cross sections and tapered edges may help minimize cross interference of unwanted magnetic flux. The magnets may be radially magnetized to provide strong magnetic dipoles perpendicular to the plane of the back plate for each partitioned section of the rotor.

The back plate may be formed of aluminum or other non-magnetically permeable material. The back plate may form part of the electric machine housing, which has side walls attached to it.

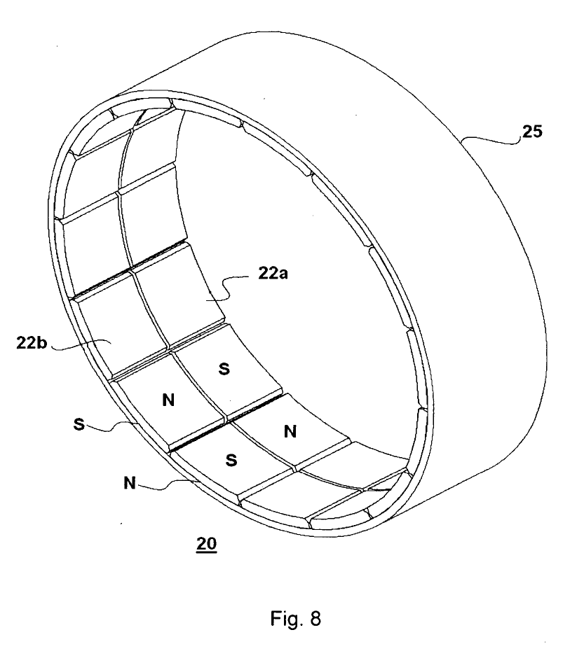

In this example, the stator has fifteen electromagnet pairs, with each pair arranged lengthwise around a circular central circular ring. As shown in FIG. 7, each electromagnetic pair is a U-shaped electromagnetic core. The two upright legs of the “U” are wound with copper wire to function as electromagnetic poles. These stator windings are switched by power electronics to form the alternating electromagnet field that forces the rotor to rotate.

Complex three-dimensional shapes of the electromagnetic cores can be used in this motor to improve performance. To make those shapes more easily, the electromagnetic cores may be manufactured from Soft Magnetic Composite (“SMC”) powder alloys or alloyed sintered powder materials (“SPM”), as opposed to laminated electrical steel.

These SMC and SPM alloys come in innovative isotropic powder matrices. Each grain in the powder matrix is insulated from the other grains, using a resin bonding agent or oxide layer. That results in extremely high electrical resistivity compared to the best high-silicon steels (1000 vs. 40 to 50 μohm cm). They also have very low eddy current loss at the relevant frequencies and magnetic flux densities.

These SMC and SPM alloys allow stringent geometrical constraints and the required electromagnetic characteristics to be specified for each particular motor design. Using these complex three-dimensional shapes may significantly reduce the weight of the stator, and make them easier to manufacture.

In this example, each electromagnetic circuit, or “phase,” of the adaptive motor has been sufficiently isolated from each of the other electromagnetic circuits to substantially eliminate electrical and electromagnetic interference between the circuits. This may increase the number of independent machine parameters that may be varied and controlled. As a result, this may increase the effective response of the electric machine to control and optimization.

In other words, each of the motor's electromagnetic circuits is sufficiently isolated so that electromagnetic and electrical interference between the circuits is substantially eliminated in order to increase the effective response of the motor to control and optimization.

In addition, each electromagnetic circuit, structurally and/or electromagnetically separated from each of the others, may receive a separate control signal from the motor controller. That controls the electrical flow in each group of electromagnetic circuits independently of electrical flow in each other group. That may allow each electromagnetic circuit, or phase, to be controlled independently of each other phase.

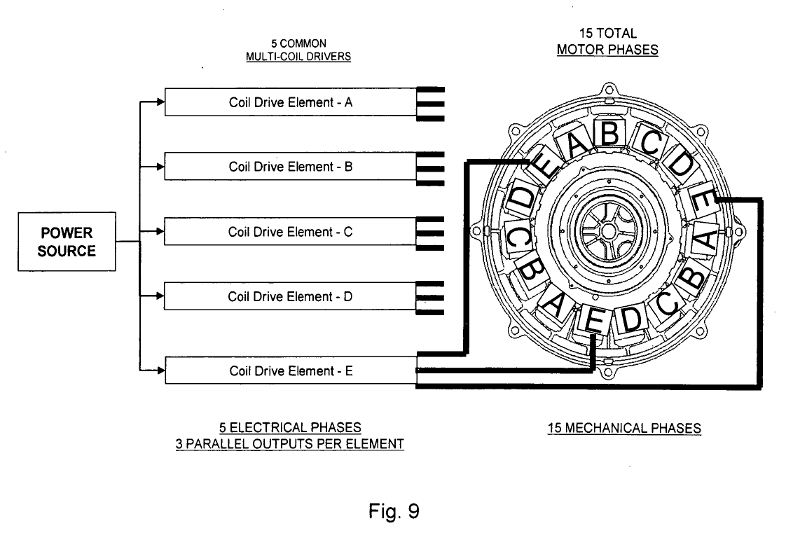

As an independent electromagnetic circuit, each “phase” of the motor can be driven independently. But to minimize the complexity of the system, and to reduce the number of power electronics required, the fifteen phases of the motor of this example are divided into five groups of three “phases” each. FIG. 9 shows this.

The motor controller controls the amount and direction of the current sent from the power source to the stator windings. It does this by controlling the gate drivers, based on inputs from current sensors, a rotor position sensor, and a speed approximator.

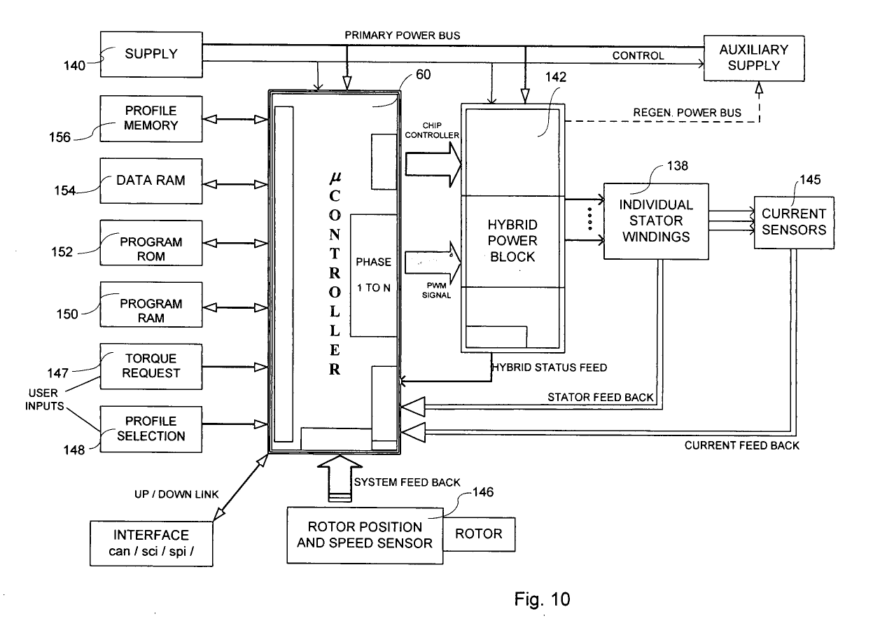

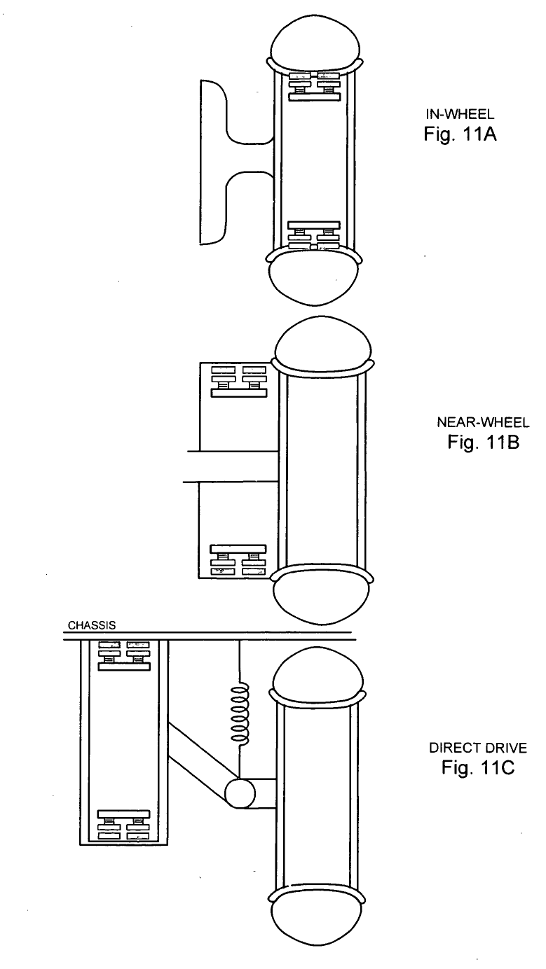

FIG. 10 shows one example of a motor controller. In this example, the controller is a Texas Instrument digital signal processor TMS320LF2407APG. The controller also needs memory to store current driving profiles, other data, and programs. In this example, the controller has four memories.

To improve performance, the motor controller may dynamically adapt the torque/speed/efficiency characteristics of the motor. As parameters—driver inputs, sensor inputs for each motor system, and sensor inputs for the vehicle—vary, the operation of the motor may be changed to adapt to those variations. In other words, the motor control scheme can be dynamically adapted to user inputs, machine operating conditions and machine operating parameters.

Most adaptive control systems will be optimized to balance:
functional requirements
performance quality
system efficiency
system safety
fault tolerance

The distributive architecture of an adaptive electric motor allows circuit independence, while balancing configuration, circuitry, power requirements, component complexity, and software complexity. Based on the user inputs and environmental, motor or system conditions, the control priorities may be adapted to optimize performance

For example, if a car requires high torque to climb a hill at low speed, from a standing start, the motor controller may adapt to provide that. If the car needs high torque to pass on a freeway at 70 miles per hour, the motor controller may provide that.

As another example, a sine waveform profile may be used by the motor controller to extend battery life through its more efficient operation. However, in most cases, a power supply is rated for a maximum current discharge rate. If the motor controller receives a control input that requires the maximum current draw, the motor output may be limited to relatively low torque if the sine waveform profile.

If the motor controller determines that the motor needs to generate more torque than the sine waveform profile can provide, the controller may switch to a square wave profile. The square wave profile will produce more torque than the sine waveform profile without exceeding the maximum rating of the power supply. However, the power loss will increase by about 40%, greatly reducing efficiency.

A variety of different algorithms may be implemented in the motor controller to achieve optimal results. For example, a motor controller for an adaptive electric motor may use a phase advance scheme to counter the problems caused by back EMF building up at high speeds.

In general, the motor controller optimizes the performance of the adaptive electric motor by dynamically selecting a control scheme in response to user inputs, machine operating conditions and machine operating parameters. To do this, a motor controller may use a variety of control algorithms, including the torque/efficiency optimizing and phase advance algorithms described above. At least three types of algorithms come to mind.

First are performance-oriented algorithms. Here, the controllable parameters are calculated to optimize performance at given speeds and torque. The torque/efficiency optimizing and phase advance algorithms discussed above fall within this category.

Other algorithms can include measures designed to damp the vibrations or other handling problems that may be caused by bumps or other irregularities in the road surface. In fact, these algorithms can be used to counteract, at least to some degree, the effects of the unsprung mass in the wheels of the car.

This software-based, dynamic damping of the in-wheel motor drive system may result in better road-holding performance and a more comfortable ride than are possible with conventional in-wheel systems. It may offer advantages over conventional, single-motor electric cars, or even over gasoline cars, in safety and comfort.

Second are algorithms oriented toward working around faults. Here, the controllable parameters are re-calculated based on specific fault information so a given speed-torque profile may be maintained. Other desired performance characteristics can also be optimized to the extent possible.

For example, the central controller can work around faults. Each “phase,” or electromagnetic circuit, of an adaptive motor may be independent. In that case, the central controller or motor controller can compensate for one phase becoming inoperable. The motor will operate, but with increased torque ripple, increased cogging and decreased torque.

That fault tolerance alone may be a big advantage over other motor designs. But with appropriate algorithms, the controllers may compensate even for these faults, reducing torque ripple and cogging, and increasing torque contribution from other phases to keep torque up.

Third are algorithms geared toward dealing with manufacturing tolerances and wear. These algorithms are based on the premise that each part of a motor, although manufactured to specification, may have some deviation from that specification. These algorithms may correct for such deviations, as well as deviations caused by wear. Because these algorithms have to do with specific motor performance, they are probably best implemented in the motor controller rather than the central controller. But they may do implemented in either place.

The motor controller must also be able to control the motor as a generator, when it performs regenerative braking. The adaptive architecture of the in-wheel motors in this example facilitate regenerative braking.

This detailed description of in-wheel adaptive motors provides two examples. There are many others. This invention should not be considered limited to these or any other examples.

1. A vehicle, comprising:
two or more wheels, and
one or more electric motors, each mounted in an in-wheel, near-wheel, or direct-drive manner,
wherein at least one motor is an in-wheel motor with torque density of at least 20 Nm/kg and comprises a multiphase machine having a rotor, a stator, the stator comprising a plurality of stator core elements, the plurality of stator core elements being arranged in groups, each group of stator core elements being associated with a corresponding one of the phases of the multiphase machine, the stator core elements in each group being structurally and electromagnetically isolated from the stator core elements in each other group, and a controller for controlling electrical flow in each group of stator core elements independently of electrical flow in each other group, whereby each phase of the multiphase machine is controlled independently of each other phase.

2. A car or other vehicle with two or more wheels and one or more electric motors to move the vehicle,
where at least one motor is an in-wheel motor with torque density of at least 20 Nm/kg.

3. A car or other vehicle with two or more wheels and one or more electric motors to move the vehicle,
where at least one motor is a near-wheel motor with torque density of at least 20 Nm/kg.

4. A car or other vehicle with two or more wheels and one or more electric motors to move the vehicle,
where each motor is mechanically linked with only one wheel of the vehicle and the torque density of at least one motor is at least 20 Nm/kg.

5. A car or other vehicle with two or more wheels and one or more electric motors to move the vehicle,
where each motor directly drives one or more wheels of the vehicle and the torque density of at least one motor is at least 20 Nm/kg.

6. A car or other vehicle with two or more wheels and one or more electric motors to move the vehicle,
where at least one motor is an in-wheel motor with each of its electromagnetic circuits being sufficiently isolated so that electromagnetic and electrical interference between the circuits is substantially eliminated in order to increase the effective response of the motor to control and optimization.

7. A car or other vehicle with two or more wheels and one or more electric motors to move the vehicle,
where at least one motor is an in-wheel motor with a motor control scheme that can be dynamically adapted to user inputs, machine operating conditions and machine operating parameters.
